(19) United States
(12) Patent Application Publication
(10) Pub. No.: US 2023/0374387 A1
(43) Pub. Date: Nov. 23, 2023

(54) Verifiable and Repairable Dry Tomb Biolandfill for Biological Carbon Sequestration And Methods of Construction

(71) Applicant: Harry William Deckman, Clinton, NJ (US)

(72) Inventor: Harry William Deckman, Clinton, NJ (US)

(21) Appl. No.: 18/316,103

(22) Filed: May 11, 2023

Related U.S. Application Data
(60) Provisional application No. 63/343,011, filed on May 17, 2022.
(60) Provisional application No. 63/432,031, filed on Dec. 12, 2022.

(51) Int. Cl. C10B 49/10; C10G 53/02; C10J 3/00

(52) U.S. Cl. CPC C10B 49/10; C10G 53/02; C10J 3/00; C10J 2300/0916; C10J 2300/0956; C10J 2300/0969; C10J 2300/0973; C10J 2300/1612

(57) ABSTRACT

The present invention is directed to a dry tomb landfill for biological carbon sequestration, and more particularly to a dry tomb biolandfill having biomass enclosed by top and bottom seals containing at least one barrier to water transport, a covering layer that functions to protect the enclosed biomass from atmospheric disturbance, one or more accessible pipes or conduits connected to the enclosed biomass, and means to monitor biomass decomposition of the enclosed biomass

### CROSS REFERENCE TO RELATED APPLICATIONS

The present application claims priority to Provisional Patent Application(s) 63/343,011 (Filed May 17, 2022) and 63/432,031 (Filed Dec. 12, 2022).

### BACKGROUND

Climate science scenarios limiting global temperature rise to less than 2 degrees by the end of the century require carbon negative options which remove CO₂ from the atmosphere. One approach to carbon negativity is to capture and store organic carbon that is photosynthetically converted from atmospheric CO₂ in growing plants and trees. It has long been recognized that the amount of carbon that could be captured from agriculture and forest lands is more than enough to offset global warming (“Can We Control The Carbon Dioxide In The Atmosphere?”, Freeman J. Dyson, Energy Vol. 2 PP 217-291. Pergamon Press 1977).

Proposals have involved growing short-lived plants which are converted to humus or allowed to accumulate in artificial peat-bogs (“Can We Control The Carbon Dioxide In The Atmosphere?”, Freeman J. Dyson, Energy Vol. 2 PP 217-291. Pergamon Press 1977) or harvesting woody biomass and burying it in trenches under a layer of soil (“Carbon sequestration via wood burial”, Ning Zeng, Carbon Balance Management 3, 1 2008, https://doi.org/10.1186/1750-0680-3-1). In both these approaches harvested biomass will be stored in a wet anerobic environment (due to groundwater invasion) where a fraction of the biomass will be anaerobically degraded releasing CO₂ and methane. The IPCC has estimated that 50% of wood will degrade in wet landfill environments releasing copious quantities of methane making the storage a net greenhouse gas emitter rather than a technology that would offset greenhouse gas emissions. A lower estimate of greenhouse gas emissions has been published for wet anaerobic degradation of wood, estimating that wet anerobic storage would be greenhouse gas neutral (“Anaerobic biodegradability of wood: a preliminary review”, M. Milke, Y. Fang, S. John, 2010 Water New Zealand Annual Conference, 22-24 Sep. 2010 Christchurch, New Zealand). In all events because of methane emissions, the simple anerobic storage of woody biomass in wet anaerobic environments is not a realistic solution to global warming. However, a solution which stores biomass and prevents rapid degradation has the potential to offset a significant fraction of the world CO₂ emissions. Of almost equal importance is finding a solution which monitors degradation of stored biomass making the solution verifiable and if needed repairable. This invention provides an unanticipated solution to both problems.

To provide perspective, a successful technology offsetting approximately a fourth of the world's greenhouse gas emissions (an amount nearly equal to 10 Giga-tonne of CO₂ equivalent per year) with harvested biomass having 50 wt. % carbon content and yearly crop yields of 10 dry metric tonne per acre would require agricultural production from ˜6 10⁸ acres or equivalently ˜2.5 10⁶ kilometer². This hypothetical scenario would require ˜17% of land used to grow row crops (wheat, corn . . . ), or ˜5% of the earth's forest land, or 7% of the earth's ranchland and pastures. By comparison, many integrated assessment models presented by the IPCC require an increase in land used for biofuel production by the year 2100 of ˜12 10⁶ kilometer², distributed between forests and bioenergy crops. The integrated assessment models reported by the IPCC suggest that such large acreages would come primarily from reductions in pasture and crop land, with a minor decrease in a category referred to as “natural land” that approximately corresponds to shrub land in other inventories of the earth's land use. While these areas of land needed for offsetting a quarter of the worlds greenhouse gas emissions are substantial, deployment at this scale is feasible if substantial atmospheric carbon drawdown is desired by the global community.

### SUMMARY OF THE INVENTION

The present invention is directed to a verifiable dry tomb biolandfill having biomass enclosed by top and bottom seals containing at least one barrier to water transport forming a dry tomb structure, a covering layer containing soil that functions to protect the enclosed biomass from atmospheric disturbance, one or more accessible, sealable solid wall pipes or conduits connected to the enclosed biomass, and means to monitor biomass decomposition of the enclosed biomass

### BRIEF DESCRIPTION OF THE DRAWINGS

The following figures are included to illustrate certain aspects of the embodiments, and should not be viewed as limiting embodiments.

FIG. 1 shows elements of a verifiable and repairable dry tomb biolandfill constructed at the earth's surface containing a dry tomb structure formed by top and bottom seals containing a single water transport barrier that encloses dry biomass with a sealable coaxial piping structure connecting the dry tomb to the surface of the biolandfill.

FIG. 2 shows elements of a verifiable and repairable dry tomb biolandfill containing a dry tomb structure and biomass constructed at the earth's surface with a sealable coaxial piping structure and top and bottom seals containing two nested water transport barriers separated by a spacer structure that encloses dry biomass.

FIG. 3 shows elements of a verifiable and repairable dry tomb biolandfill containing a dry tomb structure and biomass constructed at the earth's surface with two spatially separated sealable pipes and top and bottom seals containing two nested water transport barriers separated by a spacer structure.

FIG. 4 shows a detailed view of a configuration of layers covering the upper portion of a verifiable and repairable dry tomb biolandfill having top and bottom seals containing two nested water transport barriers separated by a spacer structure.

FIG. 5 shows a detailed view of a configuration of layers near the base of a verifiable and repairable dry tomb biolandfill having top and bottom seals containing two nested water transport barriers separated by a spacer structure.

FIG. 6 shows elements of a verifiable and repairable dry tomb biolandfill containing a dry tomb structure and biomass constructed with a base below the earth's surface with two nested water transport barriers separated by a spacer and multiple sealable pipes connecting the dry tomb structure to the surface.

FIG. 7 shows a graph of water adsorption branch isotherms at 25° C. for miscanthus, prairie cordgrass and an average of ten hardwoods.

FIG. 8 shows a graph of miscanthus water adsorption branch isotherms at 20° C., 25° C., and 4° C.

FIG. 9 shows graph of how water activity is affected by rain and water weight fraction in dried biomass.

### DETAILED DESCRIPTION

This invention pertains to the sequestration of biogenic carbon that is produced and stored by the flora on our planet as a natural consequence of its photosynthetic life cycle. For this invention biogenic carbon is harvested as biomass before the flora reaches the end of its carbon life cycle and degrades. In some embodiments the biomass is processed to produce other products, for example gaseous and liquid fuels, with a fraction of the biogenic carbon remaining unconverted but may be chemically modified. This fraction of biogenic carbon will also be referred to as biomass and in some instances referred to as chemically altered biomass.

This invention is a biolandfill composition that provides a means of safely, verifiably, efficiently, and economically storing carbon in biomass without significant degradation for hundreds to thousands of years, helping to offset CO₂ emissions and mitigating climate change. The biolandfill composition allows storage of biomass in a dry environment mitigating decomposition processes along with a means of verification of whether water has invaded the biolandfill and whether there is any significant evolution of CO₂ and/or methane greenhouse gasses from biomass decomposition. In a preferred embodiment, if an unacceptable water content or evolution of greenhouse gases is detected, a means is provided to further dry the biolandfill, repairing the tomb environment needed to store the biomass.

The biolandfill contains a dry tomb structure comprising biomass with top and bottom seals containing at least one barrier to water transport that completely surrounds the biomass. This dry tomb structure will also be referred to as a dry tomb. Level of dryness can be quantified by the water activity of gas contained within the dry tomb structure. In a preferred embodiment the biomass in the dry tomb has a low water content. The biolandfil has one or more sealable pipes or conduits with solid walls that connect the interior of the dry tomb to the earth's atmosphere. In a preferred embodiment seals on the pipes or conduits are valves which can be opened but remain closed most of the time isolating the environment in the dry tomb from the earth's atmosphere. In some instances, the sealable pipes or conduits will be referred to as pipes or conduits. If a design with top and bottom seals containing a single water barrier surrounding the dry biomass is employed, substantial care in construction of the barrier need be exercised to help insure that it remains impermeable. There is a finite probability of having a small defect in a single water barrier structure and, as such, in a preferred embodiment additional elements are incorporated into the biolandfill allowing one to purge water vapor and any other unwanted gas species from the dry tomb structure. To provide a purge, at least two sealable pipes or conduits are incorporated into the biolandfill design and are opened for purging in a manner such that gas can be flowed into one pipe or conduit and exit from the other such that it purges a portion of the gas in the dry tomb structure. By purging with relatively dry gas the biolandfill can be dried as moist gas exits. This addition of two or more sealable pipes or conduits provides a means of drying and hence repairing (if needed) the biomass storage condition in the biolandfill and this type of biolandfill will be referred to as a “verifiable and repairable biolandfill”. Biolandfills constructed with a single pipe or conduit connecting the interior of the dry tomb to the earth's atmosphere will be referred to as “verifiable biolandfills”. In one embodiment of a verifiable and repairable biolandfill, sealable pipes or conduits connecting to the earth's surface run coaxially and when opened for purging, the purge between them flows predominantly in a vertical direction. In another embodiment of a verifiable and repairable biolandfill, two or more sealable pipes or conduits are spatially separated and when opened for purging, the purge direction has a significant horizontal component. This type of dry purge is not a feature of municipal landfills all of which store moist waste. Gas composition measurements are ideally taken in verifiable and repairable biolandfills during purging and should be designed to assess CO₂, methane, and water vapor concentrations in the gas exiting the biolandfill. For verifiable biolandfills in which there is no purge, gas composition can be most readily measured when gas pressure has built up in the dry tomb and some gas flows out of an opened pipe or conduit. For gas composition measurements made with flowing gas, at least one gas analyzer should be either temporarily connected or permanently installed on at least one of the pipes or conduits. The connection can be such that all gas or a portion of gas flowing out of a pipe or conduit flows through the analyzer. A wide variety of gas analyzers are commercially available and in some instances analyzers that measure a subset of CO₂, methane, and water vapor can be used. When an analyzer is used that measures a subset of CO₂, methane, and water vapor, it is preferred to utilize an additional analyzer that completes the entire measurement set (i.e. CO₂, methane, and water vapor). In addition it is advantageous to measure the gas flow rate out of any pipes or conduits as well as the purge flow rate of gas into any pipes or conduits. When gas is not being purged or sampled, the pipes or conduits may be closed off from the earth's atmosphere. In this simplest embodiment the environment in the biolandfill is aerobic after construction and transitions to a mostly anerobic environment over a period of time. In verifiable and repairable biolandfills a portion cycles between aerobic, anoxic, and anerobic conditions due to air ingress during gas sampling, or purging, or from potential remediation operations. In one embodiment that can be a feature of both verifiable biolandfills as well as verifiable and repairable biolandfills, pressure in a closed sealable pipe or conduit is measured to assess if any gas is being evolved from the entombed biomass. In this embodiment a readable analog or digital pressure gauge is installed on at least one of the sealable pipes or conduits. It is preferred that the accuracy of the pressure gauge be 0.01 bar and more preferably 0.001 bar. Range of the pressure gauge should be at least from 1 to 1.2 bar, more preferably from 0.75 to 2 bar. In another embodiment biomass in the dry tomb structure is compartmentalized with secondary or tertiary water barriers encasing the partitioned biomass. This arrangement provides additional protection to keep biomass dry during construction of the biolandfill as well as during the lifespan of the dry tomb structure. In another embodiment that can be a feature of both verifiable biolandfills as well as verifiable and repairable biolandfills, if too much unwanted decomposition of the entombed biomass occurs the biogas generated is allowed to flow out of the biolandfill and utilized in a combustion process or processed so that at least a portion of greenhouse gases evolved are captured and sequestered. An optional embodiment has a pipe running to the base of the dry tomb structure which can be used to pump out small amounts of liquid water that are not expected but might accumulate if there are several defects in the biolandfill construction.

A preferred embodiment surrounds the sequestered biomass with top and bottom seals containing multiple water transport barriers that are nested one within another. Having multiple nested water transport barriers lowers the probability of infrequent defect alignment, significantly lowering net water transport through defects into the dry tomb structure. In a preferred embodiment there is a separating structure which is a layer or region between the nested water transport barriers. This separating structure (layer or region) can improve mechanical stability, and mass transfer resistance to the ingress of water from defects. The top and bottom seals form the outermost boundaries of the dry tomb structure and as such dimensions of the dry tomb structure is defined by the outermost extent of the top and bottom seals.

A notable aspect of the invention is biomass storage in the dry environment within the biolandfill which prevents rapid degradation and the evolution of greenhouse gasses. As noted above, the prior art has inadequately addressed greenhouse gas generation and monitoring. Proposals for simple in ground storage of biomass have been shown to be net greenhouse emitters rather than a carbon negative solution. Groundwater invades and supports growth of microorganisms that degrade the biomass and generate greenhouse gasses. A measurement of the moisture condition that allows microorganisms to grow is water activity. Water activity (a_{w}) is defined as the ratio of the water vapor pressure in gas equilibrated with the biomass to the saturated vapor pressure of pure water at the temperature of the stored biomass. Expressed as a percentage this is approximately the relative humidity. As such, a water activity (a_{w}) of 0.80 is approximately the same as a relative humidity of 80% which means the water vapor partial pressure in atmospheric pressure gas is 80% that of pure water. In aerobic environments a water activity above 0.95 will provide sufficient moisture to support the growth of bacteria, yeasts, and mold. Decreasing the water activity (a_{w}) inhibits the growth of such organisms. For food stored in aerobic environments if the water activity is controlled to 0.85 or less in the finished product the growth of organisms is sufficiently reduced so that it is not subject to the US Food and Drug regulations 21 CFR Parts 108, 113, and 114. As the water activity decreases further fewer and fewer life forms can grow. Decreasing water activity (a_{w}) below ˜0.61 has been shown to extinguish life (A. Stevenson et. al., “Is there a common water-activity limit for the three domains of life?” The ISME Journal 9, 1333-1351, 2015). Metabolism rates also decrease with decreasing water activity. The reason that life forms become less viable as water activity decreases is that to support life cells must transfer water solubilized nutrients inwards through the cell wall and water solubilized waste materials out through the cell wall. Water content strongly bound to specific sites does not act as a solvent and only free or mobile surface sorbed water can solubilize nutrients and waste. As the water activity decreases water only populates strongly bound sites such as hydroxyl groups of polysaccharides, the carbonyl and amino groups of proteins, and others on which water can be held by hydrogen bonding, by ion-dipole bonds, or by other strong interactions. This binding action is referred to as sorption behavior and can be quantified by measuring water sorption isotherms. This same basic behavior also occurs in anoxic and anaerobic environments. Although the microorganisms that live in anoxic and anaerobic environments can be different from those living in aerobic environments, they still require the transport of water solubilized nutrients and waste products across cell walls. As such the definition of a dry environment will be the same for aerobic, anoxic, and anaerobic environments. A more detailed description of the dry tomb landfill for biological carbon sequestration is found in co-pending applications 63/343,011 (Filed May, 17, 2022) and 63/432,031 (Filed Dec. 12, 2022) which are hereby incorporated by reference.

Over time water activity will thermodynamically equilibrate throughout most of the volume in a sealed dry tomb structure. This equilibration produces identical activities for water sorbed in the biomass, water vapor in the gas space. As such sampling the gas space from a dry tomb structure that has had time to equilibrate provides a means of measuring water activity. An equilibration time is taken to be six months, preferably a year, and more preferably 2 years. A dry environment is defined hereinto be a water activity in gas sampled from the biolandfill of less than 0.85, preferably less than 0.775, more preferably less than 0.75, very preferably less than 0.65, and most preferably less than 0.6. When sampling is done during purging a representative sample should be taken after the volume of gas purged into the biolandfill is more than 0.0001 of the dry tomb volume and less than one tenth of the dry tomb volume. The lower bound is set to make sure sufficient gas has flowed through the pipe or conduit being sampled. The upper bound is set by the desire to have the purge displace gas from the biolandfill without breaking through to the pipe or conduit being sampled. In a more advanced protocol purge gas breakthrough is assessed using a molecular marker species introduced into the purge gas that can be detected by the gas analyzer. In another advanced protocol the gas composition is sampled before there is time to equilibrate (i.e. less than 6 months since the previous sample) and a molecular transport model is used to assess the water activity. In another embodiment, the time dependence of water vapor concentration flowing out of a biolandfill is used to assess any spatial dependence of water activity in the dry tomb structure with the aid of a model. Without a purge gas composition can be readily measured if pressure has built up so that gas flows out of an open pipe or conduit. Alternatively, a single pipe or conduit can be used to pressurize the biolandfill. Measurement of water activity can be made by waiting for the injected gas to equilibrate with gas in the dry tomb structure and allowing gas to flow out of the pipe or conduit.

There are metabolic differences in organisms that live in aerobic, anoxic, and anaerobic environments. A consequence of these metabolic differences is that CO₂ is emitted as a greenhouse gas from aerobic biomass degradation while anaerobic and anoxic environments produce a mixture of CO₂ and methane (which is a ˜25 times more potent greenhouse gas). As such it is important to keep a dry environment in anoxic and anaerobic portions of a biolandfill. To keep biomass dry, top and bottom seals have at least one water transport barrier surrounding the biomass contained in the dry tomb structure. This barrier completely surrounding the biomass substantially prevents ingress of ground water. Its function is the opposite of water transport barriers in conventional municipal and toxic waste landfills. In conventional municipal and toxic waste landfills water transport barriers are used to prevent the contamination of ground waters from outward transport of polluted waters contained in the landfill as opposed to preventing inward transport of ground water into a dry biomass.

In a preferred embodiment top and bottom seals have at least one additional water transport barrier surrounding the biomass. In this embodiment top and bottom seals contain nested water transport barriers wherein one transport barrier is conformally enclosed within the other. An advantage of this nested dual barrier structure is that it mitigates and/or eliminates the effect of pinholes or defects in the outermost water transport barrier. Pinholes and/or defects will occur very infrequently and the probability of pinholes or defects lining up in this nested structure is very small. In an even more preferred embodiment three or more water transport barriers are nested separating the ground and ground water from the biomass. For all nested water transport barriers, spacer structures (layers or regions) can be used to set apart (i.e. separate) the nested water transport barriers. A spacer or separating structure can contain soil, compacted soil, clay, geosynthetic clay, a geotextile, a geonet, or a geosynthetic fabric. In some instances a high-capacity water sorbent is incorporated into the spacer structure. In other embodiments multiple high-capacity water sorbent materials are incorporated into the spacer structure. A high-capacity water sorbent is taken to be a sorbent that when exposed to fresh liquid water, the sorbent loading exceeds 0.5 gram of water per gram of dry sorbent material. Examples of high-capacity water sorbents are superadsorbent polymers. Thickness of a spacer structure between water transport barriers can range from 0.1 centimeter to 3 meters and more preferably 10 centimeters to 1 meter.

To keep the biomass dry for substantially long periods of time, e.g. hundreds to thousands of years, the only way for water to cross any defect free water transport barrier is by slow diffusion (i.e. no convective transport). The rate at which water diffuses through a material or membrane can be quantified by measuring the Water (Or Moisture) Vapor Transmission rate which is the amount of water passing through a given surface area per unit time from one side of the material where there is high water activity (saturated or nearly saturated) to an opposite side where there is a low water activity (dry or nearly dry). Units for Water (Or Moisture) Vapor Transmission rates are g/m²/day and measurements of this quantity are used in many industries where moisture control is critical for example packaging for foods and pharmaceuticals. In the USA, g/100 in²/day is also in use, which is 0.064516 (approximately 1/15) of the value in g/m²/day units. The Water (Or Moisture) Vapor Transmission Rate depends on temperature and water activity. For a metric, we refer to measurements at 38 C and a water activity in a range of 0.9 to 1.0 on one side of the material diffusionally transporting to the opposite side where the water activity is 0.05 or less. The Water (Or Moisture) Vapor Transmission rates of water transport barriers in these test conditions should be in a range of 0.0 to 0.5 g/m²/day, more preferably in a range from 0.0001 to 0.2 g/m²/day, even more preferably in a range from 0.001 to 0.1 g/m²/day and most preferably in a range from 0.002 to 0.05 g/m²/day. Under these measurement (i.e. test) conditions a water transport barrier with a Water (Or Moisture) Vapor Transmission rate of 0.05 g/m²/day would deliver an amount in one year equivalent to an 18 micron thick film of water covering the surface of the barrier material. In service the biolandfill temperature would be less than the test condition and the water activity difference across the barrier would be significantly less reducing the amount of water delivered by a factor ranging from 2 to 200 when the rate of delivery in the test condition is compared with that in a dry tomb structure. Under test conditions Water (Or Moisture) Vapor Transmission Rates are inversely proportional to the thickness of the barrier material (i.e. doubling thickness reduces Water (Or Moisture) Vapor Transmission Rates by a factor of 2). If there are two nested barriers with each having the same permeance as a single barrier, the water delivery rate would be reduced by a factor of 2 if there were no mass transfer resistance in the region between them. In a preferred embodiment within the seal structures there is a spacer structure separating the nested water transport barriers which offers significant mass transfer resistance. Depending on design this will reduce the water transport rate by an additional factor of 1.5 to 4. Materials that have Water (Or Moisture) Vapor Transmission Rates in the preferred range for practice of this invention are plastics that include 1 to 300 mil (1 mil=0.001 inch) thick sheets of low-density polyethylene, linear low-density polyethylene, high density polyethylene, polypropylene, polyester, and oriented polyester. Preferred materials are plastic sheets formed from 0.91 to 0.94 g/cc low-density polyethylene resins and high-density polyethylene resins having densities of 0.94 g/cc or greater. These materials have been extensively used in municipal landfills and can be readily joined to prevent leaks between sheets by a plastic welding process.

Presently, municipal landfill GM-13 specifications cover the use of products usually made from 0.91 to 0.94 g/cc low-density polyethylene resins and GM-17 specifications cover the use of products usually made from high-density polyethylene resins with densities of 0.94 g/cc or greater. Historically the higher density polyethylene (GM-17) has had the advantage of greater chemical resistance and the lower density polyethylene (GM-13) has had superior environmental stress crack performance. Preferred thickness of sheets made from low density polyethylene resins and high-density polyethylene resins are in a range from 10 to 300 mil thick, even more preferably in a range from 20 to 150 mil thick and even more preferably in a range from 40 to 80 mil thick. Clay layers (in particular bentonite) with thickness of 0.2 to 2 meters have Water (Or Moisture) Vapor Transmission Rates in the target range, however they are less preferred as a water transport barrier. Significant performance degradation of clay layers has been found in field settings. Degradation of clay barrier properties has been traced to several factors including exchanging Na ions with Ca ions in the clay structure and cyclic hydration and dehydration of the clay cap from weather and other events which leads to cracking. Thin (0.01 to 0.4 meter thick) clay or geosynthetic clay layers have an advantageous use when incorporated in layers separating water transport barriers or between the innermost water transport barrier and the biomass. In this role the clay layer acts as a water sorbent removing small quantities of water crossing the water transport barrier, as well as a weak diffusion barrier inhibiting water transport, and a swelling agent that seals any pinholes in the water transport barrier. Clays can also be used to seal overlaps in plastic sheeting that are not sealed with a thermal welding process. Superadsorbent polymers can be used in a spacer structure separating nested water transport barriers to hinder water transport. Superadsobent polymers can adsorb an amount of water that is 100-300 times their dry weight. An example of a superadsorbent polymer is Na polyacrylate. Other examples are cross-linked polyacrylates and polyacrylamides; cellulose- or starch-acrylonitrile graft copolymers; and cross-linked maleic anhydride copolymers.

The base of the dry tomb structure in the biolandfill is taken to be approximately the lowest position of any of the water transport barriers. This base can be located below the surface of the earth as would be the case in a municipal landfill, or near or at the surface of the earth. The top surface of the dry tomb structure in the biolandfill is taken to be the uppermost surface of any of the water transport barriers and this surface is usually above the surface of the earth. Maximum thickness in the vertical direction of biomass between the innermost water transport barriers in the dry tomb structure is at least 2 feet, preferably greater than 10 feet, even more preferably greater than 50 feet, most preferably greater than 100 feet and less than 2,500 feet. Maximum lateral extent of biomass in the dry tomb structure between the innermost water transport barriers measured in a plane perpendicular to the vertical is greater than 10 feet, preferably greater than 100 feet, more preferably greater than 1,000 feet and less than 10,000 feet. As such, volume of biomass enclosed in the dry tomb is greater than 355 feet³ (or 10 meter³), preferably greater than 3,550 feet³ (or 100 meter³) and more preferably greater than 35,550 feet³ (or 1,000 meter³). In a preferred embodiment the base of the dry tomb structure is sloped so that any liquid water collecting in the structure would drain to one end or more preferably a point where a pipe or conduit can be used to remove the liquid water. To aid in the drainage perforated or porous pipes or conduits running laterally can be placed close to the surface of the innermost water transport barrier at the bottom of the dry tomb structure. Ideally a laterally running pipe or conduit drains water to a place where it can be collected or accessed by a vertical pipe running to the surface of the biolandfill.

The top surface of the dry tomb structure in the biolandfill is preferably covered with a thick layer of soil to protect the dry tomb, isolating it from damage by the earth's environment (oxidation from air, rainstorms, roots from plants and trees, lightning . . . ). Thickness of the layer of soil covering the dry tomb is preferably at least 2 meters, more preferably greater than 5 meters, and most preferably greater than 10 meters. In a preferred embodiment the top surface of the dry tomb structure is covered with a geonet, geomembrane, geotextile, geocomposite, or other protective sheet to drain water and mechanically protect the outermost water transport barrier. It is also preferred to have the first meter of soil that covers the top surface of the dry tomb to be free of large rocks or boulders. In a preferred embodiment the top surface of the soil covering the dry tomb that is exposed to the earth's atmosphere has plants, grasses, or shallow rooted trees growing on it to prevent erosion.

At least one sealable solid wall pipe or conduit runs from the interior of the dry tomb structure through the layer of soil covering the tomb to the earth's atmosphere. In some instances, sealable solid wall pipes or conduits will be referred to as sealable pipes or conduits and in all instances there is some means to open and close them. A preferred embodiment seals these pipes or conduits with valves that can be opened and closed; however several other removable sealing methods can be used including screwed on caps, caps affixed to flanges, and other means of mechanically attaching removable caps. For each pipe or conduit there is at least one watertight seal to the water transport barrier preventing ground water ingress. In a preferred embodiment at any place a pipe or conduit contacts a water transport barrier there is a watertight seal to the water transport barrier preventing water ingress. This sealing keeps the integrity of the water transport barrier intact. Sealing can be done by processes such as thermal welding, gasketing, or gluing. Sealable solid wall pipes or conduits running from the interior of the dry tomb structure through the layer of soil covering the tomb to the earth's atmosphere should have low permeability to water, excellent resistance to corrosion, and excellent mechanical properties. An example of a material meeting these requirements is PVC pipe. Sealable pipes or conduits must protrude into the dry tomb and contact gas therein. It is preferred that the sealable pipes or conduits extend into the dry tomb structure at least 2 inches below the top of the innermost water transport barrier, more preferably a foot below the top of the innermost water transport barrier. In another preferred embodiment at least one of the sealable pipes or conduits extends within 4 feet of the innermost water transport barrier near the bottom of the dry tomb structure, more preferably within 2 feet of the innermost water transport barrier near the bottom of the dry tomb structure, and most preferably within 1 foot of the innermost water transport barrier near the bottom of the dry tomb structure. Sealable pipes or conduits have an end protruding above the dirt layer covering the dry tomb structure where there is an atmospheric seal that can be occasionally opened so that gas from the interior of the dry tomb can be sampled and/or purged with a flowing gas introduced into the pipes. An example of a preferable atmospheric seal is a valve. When opened, sealable pipes or conduits connecting to the atmosphere at the earth's surface will supply some oxygen into the pipe or conduit and as such a portion of the biolandfill cycles between anaerobic, anoxic and oxidative conditions unless oxygen is rigorously excluded from the pipes or conduits. It is very difficult to rigorously exclude oxygen. In principle this can be done by installing valving that purges dry nitrogen into the sealable pipes or conduits. This would increase operating expenses, and in most circumstances, it is preferred to use dry or low humidity air to purge the pipes or conduits running from the earth's atmosphere into the dry tomb structure. Atmospheric air can be used as long as water activity in the air purge (i.e. relative humidity at the temperature of the landfill) is less than 60%, preferably less than 40%, even more preferably less than 20% and most preferably less than 10%. If an atmospheric air purge is used, portions of the biolandfill will become oxidative, and over time cycle to an anoxic and potentially anerobic condition.

Within the dry tomb structure pipes or conduits may be perforated or may be porous to gather gas from different depths or zones. In most instances these perforated or porous pipes or conduits are connected (or joined) to the sealable solid wall pipes or conduits running from the interior of the dry tomb through the covering protective dirt layer to the earth's atmosphere. Perforations or porosity may be in zones or may be over a long continuous length. Nonlimiting examples of perforations are holes or slots in the pipe running within the dry tomb structure. Porosity can be imparted by making a length of pipe or conduit out of a mesh or screen structure. It is also possible to have one or more pipes running coaxially within an outermost pipe in a similar fashion to multiple completion oil and gas wells. Multiple completion oil and gas wells can isolate production from multiple oil or gas bearing zones (different depths) using parallel tubing strings within a single wellbore casing string. In a biolandfill this type of technology would allow a single pipe or conduit with one or more pipes or conduits coaxially contained therein to purge the dry tomb structure sweeping gas to the surface. It could also be used to allow measurement of gas production from different zones (or depths) in the dry tomb structure or to remove liquid water that might accumulate in the dry tomb structure. This is especially advantageous when biomass in the dry tomb biolandfill is compartmentalized with secondary or tertiary water barriers encasing the partitioned biomass. In a more preferred embodiment, there are multiple spatially separated sealable solid wall pipes or conduits running from the interior of the dry tomb structure through the water barrier or barriers and layer of soil covering the tomb to the earth's atmosphere. This arrangement allows when opened one or more sealable pipes or conduits to be used to inject gas into the dry tomb structure and one or more sealable pipes or conduits to be used to collect or sample gas that has flowed predominantly in a horizontal direction across a portion of the tomb. With this arrangement it is then possible to purge selected regions within the dry tomb structure as well as produce an approximate map of where any biogas is being generated. By locating sealable pipes or conduits far apart large volumes within the dry tomb can be purged. This allows an effective restoration and repair of the atmospheric condition in a significant portion of the dry tomb structure. Restoration and repair is accomplished by purging with low humidity gas that exits to the atmosphere as a moist gas, lowering the water content in the dry tomb structure. To lower gas pressure drop during purging it is possible to have perforated or porous pipes or conduits running laterally in the dry tomb structure. It is also possible to configure multiple pipes or conduits to access different depths (or zones). This is particularly advantageous when biomass in the dry tomb structure is compartmentalized with secondary or tertiary water barriers encasing the partitioned biomass.

To measure gas composition in the biolandfill it is preferred to have gas flow out of an opened sealable pipe or conduit running to the surface where it can be sampled with analytical instrumentation. This analytical instrumentation is connected to pipes or conduits in order to measure CO₂, methane, and water vapor compositions. Purging pipes or conduits allows a representative measurement of gas composition within a dry tomb structure. If the biolandfill is correctly constructed and operated, the buildup of gas pressure from biomass decomposition will be small so that when a sealable pipe or conduit is opened very little gas will flow and a purge will be needed to accurately measure composition within the biolandfill. To provide a more continuous measurement of gas generation, pressure in a sealable pipe or conduit can be recorded while the biolandfill is sealed off from the earth's atmosphere. For verifiable and repairable biolandfills if the sequestered biomass begins to degrade, a purge to repair the atmospheric environment in the dry tomb can be started and in some extreme cases liquid water can be pumped to the earth's surface from the base of the biolandfill. In both verifiable biolandfills as well as verifiable and repairable biolandfills sealable pipes or conduits can be used to gather and route biogas to a processing facility where it is separated or combusted or both. Ideally a separation process would capture and sequester CO₂ from the unwanted flow of biogas.

Biomass sequestered in the biolandfill can be harvested plants or trees, or chemically altered biomass left over as a waste product from chemical conversion processes. Chemical conversion technologies that produce biomass-derived “waste” include torrefaction, carbonization, anaerobic digestion, and biofuel production. All these chemically altered materials along with harvested plants or trees will be referred to as biomass.

From an economic standpoint it is preferred to generate the harvested feedstock from high productivity plants and trees (often referred to as energy crops) with dry biomass yields in a range from 1 to greater than 20 metric dry tons per acre per year. It is also preferred that the biomass sequestered not be a food crop such as corn, wheat, or other similar plant materials. A partial listing of crops that are suitable to produce biomass for the present invention is presented in Table 1. The wide range of crops shown in Table 1 increases the breadth of applicability because these feedstocks can be grown in diverse climates throughout the world. In addition, many of these crops can be grown on marginal or degraded lands with reduced yields. Since food crops are preferably not selected biomass, compromised soil and irrigation may be employed in the generation of the biomass. Weight fraction of carbon in the dry biomass of plants listed in Table 1 ranges from approximately ˜40 wt. % to ˜55 wt. %. If the biomass is simply harvested and sequestered in a biolandfill this would offset ˜1.3 to ˜1.8 metric tons of CO₂ per metric ton dry biomass sequestered.

TABLE 1
Candidate Biomass Crops

| Classification | Technical Name | Common Names |
|---|---|---|
| Herbaceous Grass | Miscanthus | Miscanthus × |
| | | giganteus, |
| | | Silvergrass |
| Herbaceous Grass | Panicum virgatum | Switchgrass |
| Herbaceous Grass | Pennisetum purpureum | Elephant Grass |
| | | Napier Grass, |
| | | Uganda Grass |
| Herbaceous Grass | Arundo donax | Giant Reed, Indian |
| | | Grass, Spanish Reed |
| Hybrid | Miscanthus × | Makarikari Grass |
| | Sugarcane | |
| Nitrogen Fixing | Pueraria | Kudzu, Japanese |
| | | Arrowroot |
| Nitrogen Fixing | Medicago sativa | Alfalfa |
| Woody | Bambusoideae | Bamboo |
| Short Rotation | Salix | Common Osier, |
| Coppice | | Basket Willow, |
| | | Willow |
| Short Rotation | Populus | Poplar, Hybrid |
| Coppice | | poplar, Eastern |
| | | Cottonwood |
| Short Rotation | Eucalypteae | Eucalyptus, Gum |
| Coppice | | Tree |
| Hybrid Tree | Transgenic Trees | Transgenic |
| | | Eucalyptus |
| Tree/Shrub | Acacia | Mimosa, Acacia, |
| | | Thorntree, Wattle |
| Tree | Pinus | Pine, Loblolly Pine |
| Aquatic | Seaweed | Kelp |
| Herbaceous Plant | Agave tequilana | Blue agave, Tequila |
| | | agave, |
| Herbaceous Plant | Saccharum | Energy Cane, |
| | | Sugarcane |

Algae is an additional high yield biomass that could be used however it requires special growth and harvesting techniques and a very high level of dryness for preservation because of its composition, thereby making it less preferable though included in the range of potential biomass sources should the aforementioned hurdles be overcome.

To help ensure dryness the biomass (either harvested or chemically altered) should be dry when loaded into the landfill. If there is too much free or sorbed water in the biomass the water activity in the sealed biolandfill will be too high and the biomass will degrade. To meet this requirement it is preferred that the water content of the completed dry tomb structure is less than 20 wt. % of the dry weight of biomass encased within the tomb, in a preferred embodiment the water content of the dry tomb structure is less than 15 wt. % of the dry weight of biomass encased within the tomb, in a more preferred embodiment the water content of the dry tomb structure is less than 10 wt. % of the dry weight of biomass encased within the tomb, in an even more preferred embodiment the water content of the dry tomb structure is less than 8 wt. % of the dry weight of biomass encased within the tomb, and in the most preferred embodiment the water content of the dry tomb structure is less than 4 wt. % of the dry weight of biomass encased within the tomb. Lower water contents leads to lower water activity in the biolandfill and in all cases it is preferred to dry the biomass as much as practical before loading it in the biolandfill. Harvested or chemically altered biomass can have water contents well above the preferred range and drying processes are often required. For example, harvested green wood (such as loblolly pine) can have water contents ranging from 40 wt. % to 60 wt. %. Approximately ⅔ of this water is located in macropores and larger mesopores that can be emptied by air drying leaving 15 wt. % to 20 wt. % adsorbed water after an air-drying process. Many other biomasses have water located in macropores that can be readily removed by air drying. It is preferred to remove as much water as possible with solar, air drying, or a combination of both. More strongly sorbed water that is left after solar or air drying of different biomasses is generally in a range from 7 wt. % to 25 wt. %. It is generally preferred to remove a fraction of the somewhat more strongly sorbed water with a heated drying method to meet dryness specifications for the biolandfill. Heated drying methods include heated shed dryers, belt dryers, tunnel dryers, trough dryers, conveyor dryers, rotary drum dryers, screw conveyed dryers, hearth dryers, moving bed dryers, and fluidized bed dryers. Heated drying techniques can reduce the water content well below 1 wt. % but require capital investment and energy costs. As such there is an optimization in any heated drying process between cost (capital and operating) of heated drying and the amount of water sorbed into the dried product. Reducing the amount of water in the sorbed product provides a safety margin below the level at which degradation occurs. In a preferred embodiment optimization of the solar drying, air drying and/or heated drying processes produce a biomass product with 1 wt. % to 20 wt. % water content, preferably 2 wt. % to 15 wt. % water content, and even more preferably 3 wt. % to 10 wt. % water content. Additionally, it may be preferred to chop the biomass into smaller pieces before drying. Chopping into millimeter to multi-centimeter sized pieces can facilitate handling and drying. A preferred method for drying chopped biomass is with a rotary dryer. For a rotary drier it is preferred to produce a product with 2 wt. % to 10 wt. % water in the biomass which for most biomass isotherms corresponds to a water activity (or dryness level) that would not support life.

To enhance biolandfill economics it is preferred to locate biolandfills within 5 to 200 miles of agricultural or forestry sites sequestering 10 to 100,000 kilotonnes per year of dried biomass in each biolandfill. This highly distributed sequestration saves cost of transporting biomass large distances. It is also envisioned that any processing such as drying, torrefaction, carbonization, anaerobic digestion, or production of liquid biofuels could be co-located with the biolandfill. These distributed biolandfills should be constructed to occupy a very small fraction of the land area used for crop production. To minimize the biolandfill footprint the stored biomass should be compacted. Compaction has the added benefits of improving mechanical stability of the biolandfill, minimizing volumes that can hold free water and improving economics. In addition, compression limits mass transfer of water and water vapor into the biomass reducing rates of degradation. A metric for compaction is biomass bulk density which excludes mass contributions from foreign substances such as soil, dirt, or plastic that may be intentionally placed in the biolandfill. In a preferred embodiment the bulk density of the compressed biomass component in the dry tomb is greater than 0.2 g/cc, in a more preferred embodiment the bulk density of the compressed biomass component in the dry tomb is greater than 0.5 g/cc, in an even more preferred embodiment the bulk density of the compressed biomass component in the dry tomb is greater than 0.75 g/cc, and in the most preferred embodiment the bulk density of the compressed biomass component in the dry tomb is greater than 1.0 g/cc. By comparison uncompressed biomass has bulk densities ranging from approximately 0.02 to 0.15 g/cc. With a biomass compaction in the range of 0.7 to 1.4 g/cc, a 100 foot vertical height in the dry tomb structure can store approximately 86,000 to 170,000 metric tons of biomass per acre. If harvested energy crops or wood are sequestered in dry tomb structures, on a yearly basis this would require approximately 0.005% to 0.01% of the land area used for agriculture or forestry.

Compressed biomass can be in the form of compressed bales or briquettes (bricks, sheets, pellets, or extrudates) placed into the biolandfill, or biomass dumped into the biolandfill and compacted in place. When biomass is compacted in place it is preferred to place a 0.1 to 4 meter thick layer of biomass into a portion of the landfill, compact the layer, repeating the process over and over to generate a compacted fill. Methods used to compact the biomass in place include techniques to compact soils, such as dynamic, vibratory, and quasi-static compaction. Dynamic compaction is a ground improvement technique that densifies soils and fill materials by using a drop weight. The weights typically range from 6 to 30 tons (up to 40 tons), and the drop heights typically range from 10 to 30 meters (30 to 100 ft), sometimes more. Vibratory compaction applies a stress to soil or fill materials repeatedly and rapidly via a mechanically driven plate or hammer. Often this is combined with quasi-static compaction methods such as rolling compaction. Quasi-static compaction techniques are commonly used in municipal landfills and apply stress to the soil or fill material at a slower rate by rolling a heavy cylinder across the surface or by the kneading action of devices such as a ‘sheepsfoot’ roller. For all methods used to compact biomass in place it is preferred to run multiple passes of the compaction equipment over the exposed surface in a manner similar to that used in soil and municipal waste compaction. Density of compressed bales is typically less than that produced by dynamic, vibratory, and quasi-static compaction. Bailing machinery is commonly used in agricultural production, compressing biomass into a block (bale) which is secured by plastic wrap or wire strapping. Bulk densities of compressed agricultural bales depend on the type of machinery used and can range from approximately 0.15 g/cc to 0.35 g/cc. Higher density compression can be achieved with reciprocating ram/piston presses, screw presses, roll presses, and extruders that produce briquettes in the form of bricks, sheets, pellets, or extrudates. This type of machinery can produce compaction pressures of 5,000 psi to 50,000 psi yielding compacted biomass briquettes with bulk densities ranging from 0.5 to 1.5 g/cc. For example, measured compaction curves for small particulate miscanthus and switchgrass require pressures ranging from 10,000 psi to 35,000 psi to achieve briquette densities ranging from 0.6 g/cc to 1.1 g/cc. In a preferred embodiment briquettes in the form of compressed biomass bricks, sheets, pellets, or extrudates are stacked together in a bundle and put in plastic bags or plastic wrapped. The purpose of the bags or plastic wrap is to aid in handling of the compressed biomass and to help keep the biomass dry during construction of the biolandfill. As such, in a preferred embodiment plastic bags or plastic wrapping is sealed so that liquid water cannot intrude into the enclosed biomass. Sealed plastic bags or sealed plastic wrapping form either a secondary or tertiary barrier to water transport. If there are no secondary water transport barriers such as sealed plastic sheeting, the sealed plastic bags or sealed plastic wrapping would form secondary water transport barriers. If there are secondary water transport barriers such as sealed plastic sheeting, the sealed plastic bags or sealed plastic wrapping would form tertiary water transport barriers. It is also preferred that the sealed plastic bags or plastic wrapping offer a resistance to mass transfer of water vapor and resist mechanical tearing or puncturing. Plastic resins that can be formed into bags or sheets meeting these requirements are low density polyethylene, linear low-density polyethylene, polyethylene resins produced with metallocene catalysts, high density polyethylene, polypropylene, and resin blends of these materials. Preferred thickness of bags or sheets is set by mechanical and economic considerations and is in a range from 1 mil to 20 mil and preferably in a range from 2 mil to 8 mil. Sealing to prevent water intrusion is done either by gluing or thermal sealing processes such as heat sealing or plastic welding. Mass of compressed biomass briquettes (bricks, sheets, pellets, or extrudates) enclosed in a bag or plastic wrapping can be in a range from 10 to 2,000 pounds, more preferably in a range from 20 to 500 pounds and even more preferably in a range from 40 to 200 pounds. Heat sealing of commonly used 5 to 100 gallon sized trash bags provides an example of plastic bags that could be used to enclose and protect compressed briquettes of biomass. Such biomass briquette filled bags or plastic wrapping are available as an item of commerce, sold to consumers holding fuel for fireplace fires.

There are a wide range of methods that can be used to construct biolandfills with the compositions and features that have been described. Construction techniques involve a wide variety of engineering and scientific practices such as construction engineering, environmental engineering, geotechnical engineering, materials science, materials engineering, site development and planning, structural engineering, surveying, water resource engineering, chemical and process engineering, analytical chemistry, pedology, agronomy, biology, and civil systems engineering. All of these disciplines are needed to construct biolandfill compositions and features that have been described. Only a brief high-level discussion touching on a few of the myriad of possible construction methods will be presented because from the description of biolandfill composition and features, those skilled in the needed scientific and engineering art will be able to devise a wide variety of methods of construction. Methods used to construct biolandfills which have a base above or near the earth's surface will differ from construction methods which have a base well below the earth's surface. Biolandfill construction would begin by preparing a surface on which the bottom water transport barrier or barriers would be installed. If the biolandfill is below the earth's surface this would involve excavation of an open pit structure while for construction at the earth's surface this would primarily involve grading the surface of the land. Provision is also made to drain rainwater from the excavated or graded structures as well as from the biolandfill when it is being filled. Sloping newly exposed soil surfaces so water drains to a spot where it can be pumped or channeled to a place it can be disposed of would be but one example of such a provision. Others are diverters, gutters, plastic sheeting, or tarp systems designed to channel rainwater away from the biomass during construction of the dry tomb structure. Different types of diverters or gutters will be used throughout construction and can be made from earthen structures, plastics, tarps, or sandbags.

In a preferred embodiment a high-capacity adsorbent is used during construction to prevent rainwater or dew from soaking into the biomass composite being filled. The high-capacity adsorbent is used to form a temporary barrier or as part of a temporary barrier that mitigates the effects of rain or dew. In the most preferred embodiment the high-capacity sorbent is regenerable. The sorbent can be spread onto the exposed surface of the biomass and mechanically gathered up before more biomass is added. Alternatively, it can be placed in water permeable bags such as burlap bags, placed over the biomass to prevent water intrusion, and taken up before more biomass is added. Alternatively, it can be composited with a geotextile which is placed over the exposed surface of the biomass and taken up before more biomass is added. In another embodiment it is placed in regions where tarps or temporary geomembranes, or other covering materials adjoin to prevent water intrusion through gaps, overlaps, or seams. In this embodiment it can be placed either above or below gaps, overlaps, or seams in tarps, temporary geomembranes, or other covering materials. In all instances the high-capacity adsorbent blocks flow of liquid water through gaps, overlaps, or seams into the dry biomass being filled. From economic considerations in all cases it is preferred to use a regenerable high-capacity adsorbent that can be reused during construction. To reuse the high-capacity adsorbent it is regenerated thermally, by exposure to dry air, or by outdoor exposure to wind and solar radiation. High-capacity regenerable adsorbents for this application should have a working capacity of at least 0.5 grams of water per gram of dry sorbent. Examples of regenerable high-capacity adsorbents are superadsobent polymers that can adsorb an amount of water that is 50 to 400 times their dry weight when exposed to fresh water. An example of a superadsorbent polymer is Na polyacrylate. Other examples are cross-linked polyacrylates and polyacrylarnides; cellulose- or starch-acrylonitrile graft copolymers; and cross-linked maleic anhydride copolymers.

To construct the biolandfill, the surface of the land is excavated and graded. Construction of protective layers for the bottom seal is then begun on what will become the bottom of the dry tomb structure. Once protective layers are in place construction of the bottom seal is begun with the instillation of at least one water transport barrier. Additional water transport barriers may be installed at this point along with any protective and spacer structures that become part of the bottom seal. Following this step biomass can be added into the biolandfill. It is envisioned that the biomass would be stored at or near the biolandfill site. Ideally storage would be in a relatively dry condition such as under a tarp or in a warehouse or shed and if needed it would be dried and possibly chopped before adding it into the biolandfill being constructed. The way in which it is added depends significantly on how the biomass has been compressed. If it is compacted with equipment that chops, dries, and produces biomass briquettes (potentially plastic wrapping or bagging them) it can be physically stacked in the biolandfill. Similarly compressed dry bales of biomass that are potentially plastic wrapped can be physically stacked within the biolandfill. When compressed biomass is stacked as briquettes or bales, earthworks may in some instances be constructed to hold them in place, providing an anchoring point for a temporary tarp system, or providing drainage for rainwater, or providing the base for a temporary canopy structure used to protect areas being filled from rain. Potentially these earthworks could occupy 25% of the volume of the finished dry tomb structure and would build up as the height of the stacked biomass increases. One form of earthwork would be a dike structure or earthen causeways forming channels into which the compressed biomass is stacked. In addition, these earthworks could be used to compartmentalize regions of the biolandfill with sealed plastic sheeting that acts as a secondary water transport barrier. If secondary water transport barriers are installed then any plastic wrapping or bagging of compressed biomass would provide a tertiary water transport barrier. If there is no compartmentalization with plastic sheeting then plastic wrapping or bagging of compressed biomass would be providing a secondary water transport barrier.

For mechanical compaction, biomass may comprise a layer in a portion of the biolandfill and mechanical compaction equipment is run over it in multiple passes to densify it. In some instances, the biomass will have been chopped before it is dumped. Construction with this type of compaction can be done with or without earthworks. To keep biomass dry, temporary tarp systems and/or canopies can be constructed. In addition, plastic sheeting can be installed to seal off areas that are fully compressed. Such sealed plastic sheeting compartmentalizes the biolandfill and provides a secondary water transport barrier. In all events the biolandfill is gradually built up from the base and as it rises the desired piping structure can be built, or installed later for example by drilling. As it rises above the earth's surface to its filled height, the top seal is completed. This involves instillation of at least one water transport barrier and any spacer structures, or additional water transport barriers, or additional layers used to protect the top seal. Soil is used to cover completed water transport barriers as they are constructed, or after the dry tomb structure has been finished. Sealable piping rising above the completed biolandfill surface can be finished with instillation of valving and provision to connect to analytical instrumentation. For verifiable and repairable biolandfill designs a provision is also made to be able to flow purge gas.

The following examples illustrate aspects of the invention.

### Example 1

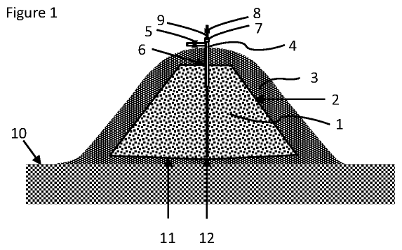

This example illustrates a simple form of a verifiable and repairable biolandfill. A cross-section showing components of the verifiable and repairable biolandfill is shown in FIG. 1. This is a dry tomb biolandfill containing dry biomass [1] formed by top and bottom seals containing a single barrier to water transport [2] surrounding the region containing dry biomass along with two coaxially running sealable solid wall pipes (or conduits) [4, 9] connecting the surface of the biolandfill to the interior of the dry tomb along with atmospheric isolation valves [5, 8] that can be opened when sampling gas composition or purging with gas. Top and bottom seals containing the water transport barrier [2] delineate the boundary of the dry tomb. The dry tomb structure is constructed at the earth's surface [10] but is subterranean because it is covered with a thick layer of soil [3] that protects it from environmental disturbance. In other potential embodiments the earth's surface [10] is excavated and the base of the dry tomb structure is located below the surface of the earth at depths similar to municipal landfills or mining operations. Features [1, 2, 3, 4, 5, 8, and 9] comprise elements of verifiable and repairable dry tomb biolandfills capable of sequestering biomass. In addition, there must be a hermetic seal that prevents water leaking through water transport barriers. In this embodiment there is only one hermetic seal [6] because one of the sealable pipes (or conduits) [9] runs coaxially inside of the other [4]. Embodiments 3 and 6 identify non-coaxial piping arrangements that provide the essential elements of verifiable and repairable dry tomb biolandfills capable of sequestering biomass. In this embodiment the smaller diameter sealable pipe [9] is coaxially sealed [7] to the larger diameter sealable pipe [4] mechanically supporting the coaxial piping and preventing ingress of atmospheric water into the coaxial piping structure. As shown the second smaller diameter sealable pipe [9] comes almost to the base [12] of the dry tomb structure. This smaller diameter sealable pipe [9] has a valve [8] that seals the pipe from the atmosphere. When opened this valve [8] can be used in combination with the valve [5] on the larger diameter sealable pipe [4] to flow a purge and sample gas from the biolandfill, or simply purge water and moisture from the biolandfill, or to handle unanticipated amounts of biogas generation. Depending on preference the purge can be flowed from top to bottom of the dry tomb or bottom to top of the dry tomb. It should be noted that purges such as this are not a feature of municipal landfills. In addition, it is preferred that the base of the dry tomb structure [11] be sloped to drain water to a spot where it can be collected. As shown the spot where water drains to [12] is near the lateral midpoint of the biolandfill. By changing the grading this spot [12] can be moved laterally anywhere across the base of the biolandfill. It is also possible to excavate a depression at this spot providing an option to accumulate a larger volume of water. It should also be noted that FIG. 1 is a schematic drawing and is not to scale. For the embodiment shown in FIG. 1 the lateral extent of biomass near the bottom of the landfill is in a range from 100 to 1,000 feet. Height of the region containing biomass (approximately from locations [12] to [6]) is between 30 and 400 feet. In this example the water transport barrier [2] is made from thermally welded sheets of 80 to 160 mil thick polyethylene. Optionally to mechanically protect the water transport barrier [2] clay layers, geonets, geomembranes, geotextiles, geocomposites or combinations thereof can be located on one or both sides of the polyethylene sheets. This mechanical protection would become a component in the top and bottom seals. For this embodiment the larger sealable pipe [4] has a diameter between 4 and 8 inches and the inner sealable pipe [9] has a diameter between 1 and 3 inches. Both sealable pipes [4, 9] have solid walls and are made from PVC plastic. Thickness of the soil layer [3] covering and protecting the upper surfaces of the dry tomb structure is in a range between 20 and 60 feet. The sequestration region of the dry tomb structure [1] has a biomass volume fraction of at least 40% more preferably this region [1] has a biomass volume fraction greater than 60% and most preferably this region [1] has a biomass volume fraction greater than 80%. Many other materials can be included in this region including gas voids, soil, clay, and secondary or tertiary water transport barriers. This region [1] may also be compartmentalized with water transport barriers, soil structures, earthworks, or clay structures. In all instances biomass in this region [1] is compressed to a bulk density of greater than 0.2 g/cc and the dry tomb has an average water activity of less than 0.85.

The biolandfill described in this embodiment is verifiable and repairable. Verification can be done by installing a pressure gauge on one of the sealable pipes [4 or 9] that connects the interior of the dry tomb to the atmosphere. Biomass decay will cause pressure in this sealable pipe [4 or 9] to rise as long as the valves [5, 8] remain closed. By monitoring the pressure gauge one can assess biomass degradation. More preferably verification is done using analytic instrumentation connected to one of the sealable pipes [4 or 9] to measure composition of gas displaced out of the biolandfill from a purge flowed into the opposite sealable pipe [9 or 4] with valves [5 and 8] opened. If significant biomass degradation is detected, the biolandfill can be purged with dry gas to remove water. This type of dry purge provides a means of repairing the sequestration conditions in the dry tomb biolandfill. When the biolandfill described in this example is constructed a means to introduce (i.e. flow) purge gas into the biolandfill may not necessarily be in place. In this case the biolandfill would still be verifiable because biomass degradation can be measured by monitoring any buildup of pressure from biogas generation. Alternatively, if pressure has built up, gas composition can be measured by letting sufficient gas flow out from the dry tomb to obtain a representative gas sample. As such, at the time of construction the biolandfill would be an example of a “Verifiable Dry Tomb Biolandfill for Biological Carbon Sequestration”. Once equipment to flow purge gas is added the biolandfill would become a “Verifiable and Repairable Dry Tomb Biolandfill for Biological Carbon Sequestration”.

Without the coaxially running pipe [9] there would be only one pipe [4] running from the surface of the earth to the interior of the dry tomb structure. This would make a biolandfill (without a second pipe) formed from elements [1, 2, 3, 4, 5, 6, 10, 11, and 12] an example of a “Verifiable Dry Tomb Biolandfill for Biological Carbon Sequestration”.

### Example 2

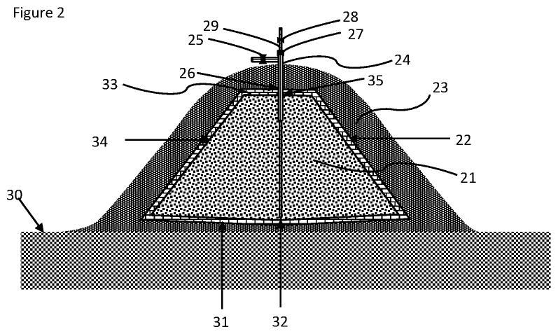

Example 2 pertains to an improvement in the top and bottom seal structure utilized in Example 1 and a cross-section of the improved biolandfill is illustrated in FIG. 2. This example has top and bottom seals that contain two water transport barriers [22, 34] while Example 1 had only one water transport barrier [2]. FIG. 2 shows a cross-sectional view of a dry tomb structure [22, 33, 34] containing dry biomass [21]. There are two barriers to water transport [22, 34] surrounding a region [21] containing dry biomass along with two sealable solid wall pipes (or conduits) [24, 29] connecting the surface of the biolandfill to the interior of the dry tomb with atmospheric isolation valves [25, 28] that can be opened when sampling gas composition or purging with gas. The water transport barriers [22, 34] are nested with a spacer structure (or layer) [33] separating them that can contain soil, compacted soil, clay, geosynthetic clay, a geotextile, a geonet, a geosynthetic fabric, a high-capacity sorbent, and combinations thereof. This layer serves to mitigate defects in the outer water transport barrier [22]. Thickness of this separating layer (or spacer structure) [33] is in a range from 0.05 to 1 meter. In some additional embodiments the composition of the separating layer (or spacer structure) can be different on the top bottom and sides of the biolandfill. In some additional embodiments the top and bottom seals have additional layers that mechanically protects them from ground disturbance or provides extra protection to the ingress of water (such as a clay layer or a geonet draining water away from the biolandfill). In some embodiments the top and bottom seal have another layer (or layers) on the inside of the inner transport barrier [34] that mechanically protects it from mechanical disturbance from machinery used to place biomass in the landfill or to provide extra protection to the ingress of water (such as a clay layer). The nested water transport barriers [22, 24] and spacer structure [33] forms the top and bottom seals in the biolandfill. These seals delineate the boundary of the dry tomb structure.

The dual water transport barrier structure [22, 33, 34] in the top and bottom seals necessitates two hydraulic seals [26, 35] between the sealable pipe [24] running to the surface from the interior of the dry tomb structure and the water transport barriers [22, 34]. In a different embodiment the sealable pipe [24] is sealed to just one of the water transport barriers. Other aspects of this embodiment are similar to the embodiment shown in FIG. 1. The base of the dry tomb structure [31] is sloped to drain water to a spot where it collects [32]. There is a smaller diameter second sealable pipe [29] running coaxially inside of the sealable pipe [24] that connects the interior of the dry tomb through the water transport barriers to the surface of the biolandfill. This smaller diameter sealable pipe [29] is coaxially sealed [27] to the larger diameter sealable pipe [24] mechanically supporting the coaxial piping and preventing ingress of atmospheric water into the coaxial piping structure. The second smaller diameter sealable pipe [29] comes almost to the base [32] of the dry tomb structure. This smaller diameter sealable pipe [29] also has a valve [28] that seals the pipe from the atmosphere. When opened this valve [28] can be used in combination with the valve [25] on the larger diameter sealable pipe [24] to flow a purge and sample gas from the biolandfill, or simply purge water and moisture from the biolandfill, or to handle unanticipated amounts of biogas generation. Depending on preference the purge can be flowed from top to bottom of the dry tomb or bottom to top of the dry tomb. The base of the biolandfill is slightly above the surface of the earth [30] and protected from the earth's environment by a thick layer of soil [33]. Similarly FIGS. 1 and 2 are schematic drawings and are not to scale.

This embodiment provides another example of a verifiable and repairable biolandfill for biological carbon sequestration. When the biolandfill described in this example is constructed a means to introduce (i.e. flow) purge gas into the biolandfill may not necessarily be in place. In this case the biolandfill would still be verifiable because biomass degradation can be measured by monitoring any buildup of pressure from biogas generation. Alternatively, if pressure has built up, gas composition can be measured by letting sufficient gas flow out from the dry tomb to obtain a representative gas sample. As such, at the time of construction the biolandfill would be an example of a Verifiable Dry Tomb Biolandfill for Biological Carbon Sequestration. Once equipment to flow purge gas is added the biolandfill would become a Verifiable and Repairable Dry Tomb Biolandfill for Biological Carbon Sequestration.

Without the coaxially running pipe [29] there would be only one pipe [24] running from the surface of the earth to the interior of the dry tomb structure. This would make a biolandfill (without a second pipe) formed from elements [21, 22, 23, 24, 25, 26, 30, 31, 32, 33, 34 and 36] an example of a Verifiable Dry Tomb Biolandfill for Biological Carbon Sequestration.

### Example 3

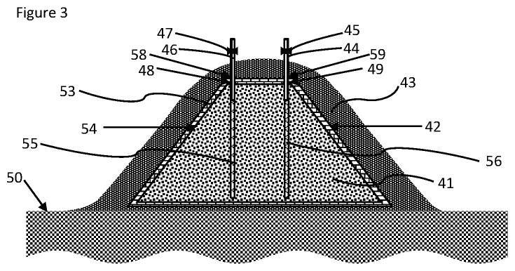

A cross-section of this embodiment is illustrated in FIG. 3 showing a different way of purging (flowing gas) through the biolandfill. In Example 2 (illustrated in FIG. 2), a purge gas would flow in a vertical direction (top to bottom or bottom to top). In this embodiment the purge flows in a predominantly horizontal direction between two slotted (or porous pipes) [55, 56]. These pipes are mechanically joined to two sealable solid wall pipes [44, 46] which run from the interior of the dry tomb to the surface. Top and bottom seal structures in this example are similar to Example 2 and contain nested water transport barriers [42, 54] and a spacer structure [53] with the boundaries of the dry tomb delineated by the top and bottom seals. The sealable solid wall pipes [44, 46] are hermetically sealed [48, 49, 58, 59] to both the inner [54] and outer [42] water transport barriers to prevent ingress of water into the dry tomb structure [42, 53, 54] containing dry biomass [41]. In another embodiment the pipes are sealed to just one of the water transport barriers. To purge the biolandfill, relatively dry gas such as low humidity air is injected by opening valves [45, 47] that seal the solid wall piping [44, 46] and gas is injected into one of the solid wall pipes and flows out the other. Within the dry tomb, slotted (or porous) piping [55, 56] mechanically connected to the sealable solid wall pipes [44, 46] injects and collects gas from the region containing biomass [41]. Gas flows in a predominantly horizontal direction and can be used to sample gas composition from a significant portion of the dry tomb, or to purge excess water vapor, or to purge unwanted quantities of biogas, or to control the degree of anoxic and anerobic conditions within the dry tomb. Studying the time dependence of the composition flowing out allows one to produce an approximate map of gas composition within the dry tomb. The base of the dry tomb structure is not sloped in the fashion shown in FIG. 2 however, it is possible to practice this embodiment with a sloped base. In most other respects the structure of the biolandfill is similar to that shown in FIG. 2 (Example 2). The dry tomb is constructed at the earth's surface [50] and covered with a layer of soil [43]. Top and bottom seals containing dual water barriers [42, 54] with a spacer structure [53] separating them are used to keep a low water activity in the biolandfill. Again, it should be noted that FIG. 3 is a schematic drawing and is not to scale and that this is an example of a Verifiable and Repairable Preserved Biolandfill for Biological Carbon Sequestration. When the biolandfill described in this example is constructed a means to introduce (i.e. flow) purge gas into the biolandfill may not necessarily be in place. In this case the biolandfill would still be verifiable because biomass degradation can be measured by monitoring any buildup of pressure from biogas generation. Alternatively, if pressure has built up, gas composition can be measured by letting sufficient gas flow out from the dry tomb to obtain a representative gas sample. As such, at the time of construction the biolandfill would be an example of a Verifiable Dry Tomb Biolandfill for Biological Carbon Sequestration. Once equipment to flow purge gas is added the biolandfill would become a Verifiable and Repairable Dry Tomb Biolandfill for Biological Carbon Sequestration.

Without a second piping structure [46, 55] there would be only one piping structure [44, 56] running from the surface of the earth to the interior of the dry tomb structure. This would make a biolandfill (without a second piping structure) formed from elements [41, 42, 43, 44, 45, 49, 50, 53, 54, 56, and 59] an example of a Verifiable Dry Tomb Biolandfill for Biological Carbon Sequestration.

### Example 4

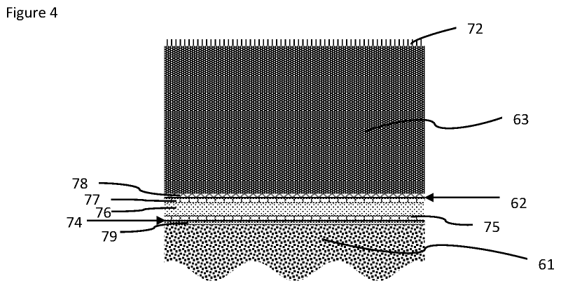

This embodiment is shown in FIG. 4 and illustrates an alternative configuration of the top seal structure that contains dual water transport barriers separated by a spacer structure. A protective layer of thick soil [63] with vegetation growing on its surface [72] covers a layer [78] that protects the outermost water transport barrier [62]. Thickness of the soil layer[63] is in a range from 10 to 100 feet and the first three feet (˜1 meter) above the layer [78] that protects the outermost water transport barrier [62] is substantially boulder and rock free. In this embodiment the layer [78] that protects the outermost water transport barrier [62] is a geonet that drains water. In other embodiments this could be a clay layer, a synthetic clay layer, a geocomposite, a geotextile, a geomembrane or other similar materials. Additionally, the protective layer [78] can be a combination of such protective materials. The outermost water transport barrier [62] is made from sheets of 40 to 160 mil thick polyethylene that have been thermallyjoined with welded seams that prevent hydraulic flow of ground water. The outermost water transport barrier [62] is separated from the innermost water transport barrier [74] by a spacer structure composed of three layers [75, 76, 77]. The top and bottom layers in the spacer structure [77, 75] are composed of a 0.05 to 1 foot thick layer of geosynthetic clay and the middle layer in the spacer structure [76] is composed of a 0.1 to 2 feet thick layer of rock free compacted soil. This is the simplest composition for the middle layer and there are a wide variety of other options including some that incorporate a high-capacity sorbent in this layer [76]. The spacer structure [75, 76, 77] mechanically protects the water transport barriers [62, 74] and also provides a mass transport resistance for the ingress of water. Additionally, water ingress into the geosynthetic clay layers [75, 77] will swell them helping to seal any defects in the water transport barriers [62, 74]. There are many other possible embodiments of spacer structures [75, 76, 77], with some having additional layers and other having fewer or different layers. An additional protective layer [79] is located between the region containing compressed entombed biomass [61] and the innermost water transport barrier [74]. When incorporated into a biolandfill design this layer can provide additional mechanical protection for the water transport barriers [62, 74] or additional mass transfer resistance to water ingress. In this embodiment it is a 0.2 to 1 foot thick layer of bentonite clay. It should be noted that FIG. 4 only shows the uppermost layers in the biolandfill and the uppermost portion of the region containing biomass [61]. In this embodiment the top seal structure [62, 74, 75, 76, 77, 78, 79] is composed of the water transport barriers, the spacer structure and all mechanical protection layers.

### Example 5

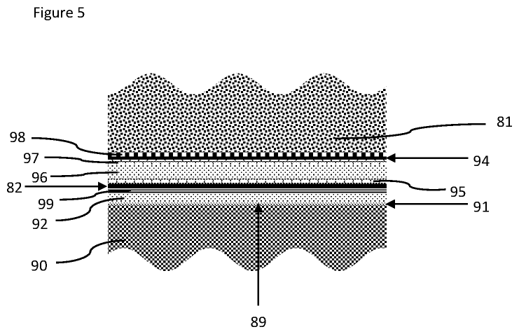

This example is shown in FIG. 5 and illustrates an alternative embodiment of a configuration of the bottom seal structure [82, 94, 95, 96, 97, 98, 99] with dual water transport barriers [82, 94] separated by a spacer structure [95, 96, 97]. The biolandfill is constructed using a surface [91] that has been graded or excavated from the earth [90]. Above the base [89] of the biolandfill a layer [92] of rock free compacted soil is installed on the graded or excavated surface [91]. This provides a degree of protection for the bottom seal structure [82, 94, 95, 96, 97, 98, 99]. The lower extremity of the bottom seal structure has a protective layer [99] which in this embodiment is a 1 to 4 mm thick geotextile. A wide variety of other protective layers could be used including a layer of bentonite clay, or a geocomposite, or a geotextile, or a geonet. Alternative embodiments dispense with these protective layers and others have additional protective layers. What will become the outermost water transport barrier [82] is installed on top of the uppermost protective layer [99]. This water transport barrier [82] along with an inner water transport barrier [94] is made from sheets of 40 to 160 mil thick polyethylene that have been thermally joined with welded seams that prevent hydraulic flow of ground water. A spacer structure consisting of three layers [95, 96, 97] is installed on top of the outermost water transport barrier [82]. Top and bottom layers in the spacer structure [97, 95] are composed of a 0.05 to 1 foot thick layer of geosynthetic clay and the middle layer in the spacer structure [96] is composed of a 0.1 to 2 foot thick layer of compacted rock free soil. This is the simplest composition for the middle layer and there are a wide variety of other options including some that incorporate a high-capacity sorbent in this layer [96]. Similarly, to Example 4, the spacer structure [95, 96, 97] mechanically protects the water transport barriers [82, 94] and also provides a mass transport resistance for the ingress of water. Clay layers [95, 97] repair defects transporting water by swelling to shut hydraulic flow off. Other possible embodiments of spacer structures [95, 96, 97], can have additional layers and others can have fewer or different layers. On top of the spacer structure an inner water transport barrier [94] is installed and covered with a layer protecting [98] it from machinery used to form the region containing compressed biomass [81]. In this embodiment the protecting layer [98] is a geotextile however a wide variety of other materials can be used. In this embodiment the bottom seal structure [82, 94, 95, 96, 97, 98, 99] is composed of the water transport barriers, the spacer structure and all mechanical protection layers.

### Example 6

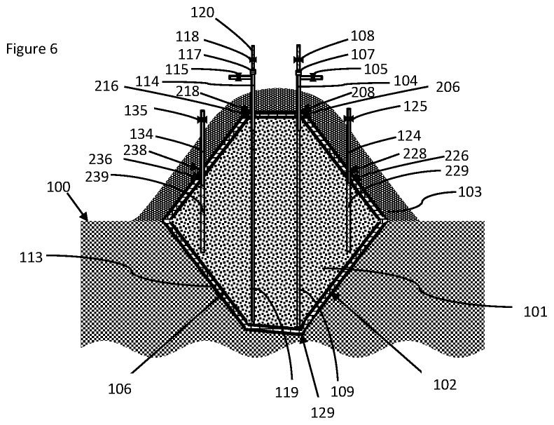

This embodiment is illustrated in FIG. 6 showing elements of a verifiable and repairable dry tomb biolandfill constructed with a base [129] well below the earth's surface [100]. The cross-sectional view in FIG. 6 shows a schematic drawing (not to scale) of two water transport barriers [102, 106] separated by a spacer structure [113] forming the top and bottom seals [102, 106, 113]. These seals [102, 106, 113] are the boundaries of a dry tomb structure containing a region with a dry biomass [101] that extends from well below to well above the earth's surface. Base of the dry tomb structure can be in a range from 20 to 80 feet below the earth's surface and the top of the dry tomb structure can be in a range from 30 to 300 feet above the earth's surface. Lateral extent of the dry tomb structure is in a range from 100 to 1000 feet. Top of the biolandfill extends in a range from 20 to 100 feet above the dry tomb structure because a thick layer of soil [103] is installed to protect the dry tomb structure [102, 106, 113]. Six solid wall sealable pipes [124, 104, 109, 114, 120, 134] extend from the surface into the dry tomb structure. All have valves [125, 105, 108, 115, 118, 135] that permit flowing a purge gas and/or gas sampling. To prevent ground water invasion solid wall sealable pipes [124, 104, 114, and 134] are hermetically sealed [228, 208, 218, 238] to the outer water transport barrier [102]. In addition, these pipes [124, 104, 114, and 134] are hermetically sealed [226, 206, 216, 236] to the inner water vapor transport barrier [106]. In an alternative embodiment these solid wall sealable pipes [124, 104, 114, and 134] are hermetically sealed to just one of the water transport barriers. One of the sealable pipes [109] is coaxially located inside of another sealable pipe [104] and runs almost to the base [129] of the dry tomb structure which is sloped to collect any unexpected (unwanted) liquid water draining to the base. It is supported and sealed to sealable pipe [104] by flange [107]. Inner diameter of the sealable pipe [109] running almost to the base [129] of the dry tomb structure is in a range from 2 to 8 inches so that if needed, a pump can be inserted downhole to bring to the surface any unexpected (unwanted) water that might accumulate. The valve [108] installed on this pipe [109] is either removable or when opened has a clearance to allow a pump to be inserted downhole. There is a wide variety of downhole pumps available, and many have been used in oil and gas wells. In addition, these coaxially running pipes [109, 104] can be used to flow gas through a portion of the dry tomb structure in a predominantly vertical direction. Shown in FIG. 6 is another coaxial piping arrangement [120, 114]. A flange [117] seals the inner pipe [120] to the outer pipe and helps support the inner pipe as well as a porous pipe [119] that the inner solid wall sealable pipe [120] joins to inside the dry tomb structure. This porous pipe [119] can be used to distribute purge gas throughout most of the height of the dry tomb structure. Towards the outer periphery of the landfill there are two additional solid wall sealable pipes [124, 134] coming to the surface. Both of these solid wall sealable pipes [124, 134] are joined to slotted pipes [229, 239] within the dry tomb structure. These slotted pipes can be used to distribute purge gas from near the periphery of the dry tomb structure. Used in combination the solid wall sealable piping [124, 104, 109, 114, 120, 134] at the surface can be used to purge and sample gas from most of the volume of the dry tomb structure.

If significant biomass degradation is detected, there are multiple ways of purging the dry tomb structure with dry gas to remove water and/or pumping liquid water out of the dry tomb. These types of water vapor and liquid water removal provide a means of repairing the sequestration conditions in the biolandfill. When the biolandfill described in this example is constructed a means to introduce (i.e. flow) purge gas into the biolandfill may not necessarily be in place. In this case the biolandfill would still be verifiable because biomass degradation can be measured by monitoring any buildup of pressure from biogas generation. Alternatively, if pressure has built up, gas composition can be measured by letting sufficient gas flow out from the dry tomb to obtain a representative gas sample. As such, at the time of construction the biolandfill would be an example of a Verifiable Dry Tomb Biolandfill for Biological Carbon Sequestration. Once equipment to flow purge gas is added the biolandfill would become a Verifiable and Repairable Dry Tomb Biolandfill for Biological Carbon Sequestration.

### Example 7

This example illustrates a way of quantitively predicting the water activity within a dry tomb structure filled with biomass. It also provides a way of determining how dry the biomass loaded into the dry tomb structure has to be.

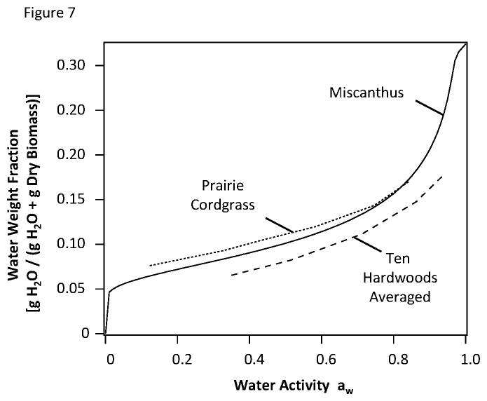

Biomass acts as a water sorbent and example isotherms are shown in FIG. 7.

Isotherms in FIG. 7 show H₂O uptake at 25 C in various biomasses as activity of water is increased in units of:

Weight fraction of H₂O sorbed=mass H₂O sorbed/{mass H₂O sorbed+mass dry biomass}) Eq. 3

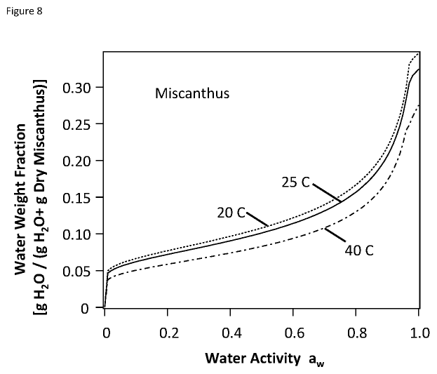

This type of isotherm measurement is often referred to as an adsorbtion branch isotherm and differs slightly from desorbtion branch isotherms measured as the water activity is decreased. The adsorption isotherm for miscanthus (a highly productive energy crop) is shown over a full range of water activity. At very low water activity (a_{w}<0.02) the water loading rises sharply due to water populating strongly bound sites. In the region of interest for biomass storage (a_{w} ranging from 0.05 to 0.85), the amount of sorbed water rises gradually from about 5 wt. % to ˜20 wt. %. At higher water activity (a_{w}>0.85) loading of water rises much more rapidly due to filling of mesopores and macropores in miscanthus. FIG. 7 also shows water adsorption isotherms covering the region of interest for long term sequestration of prairie cordgrass and hardwood. The hardwood isotherm is an average for ten different hardwoods (Red Oak, White Oak, Yellow Poplar, Sweetbay, White Ash, Green Ash, Red Maple, and American Elm). It is seen that in the region of interest of water activity for biomass storage, the isotherms are qualitatively similar to miscanthus. This qualitative similarity extends to most other forms of biomass in part because the isotherm in this region is set by water adsorption into mesopores and some macropores. There is a modest temperature dependence for the thermodynamics of adsorption into mesopores and micropores and FIG. 8 illustrates this with 20 C, 25 C, and 40 C miscanthus water adsorption isotherms. It is seen that a significant portion of the difference between them comes from the temperature dependence of strongly adsorbed water that governs shape of the isotherm at low water activity (a_{w}<0.02). As such with a limited number of isotherms one can make quantitative estimates of the biomass dryness level required.

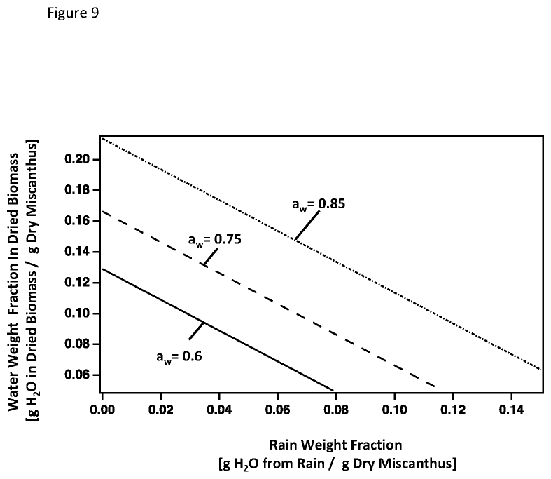

To illustrate this, dryness requirements for miscanthus sequestration will be considered as an illustrative case. The amount of water that will eventually wind up in miscanthus sequestered within a biolandfill is the sum of the amount of water accumulated from rain and the amount of water introduced when the dried biomass (miscanthus) is placed into the biolandfill. Using this fact along with the graph shown in FIG. 7, one can calculate for water activities of 0.85, 0.75, and 0.6 the relationship between the allowable water fraction in dried biomass placed into the dry tomb and the grams (or tonnes) of rainwater incorporated during construction per gram (or tonne) of completely dry biomass. This relationship is shown graphically in FIG. 9 where dryness requirements to obtain water activities of 0.85, 0.75, and 0.6 are shown. The vertical axis is a dimensionless ratio of the mass of water in dried biomass placed into the dry tomb to the rigorously dry miscanthus weight placed into the dry tomb. This mass ratio of water in dried biomass to completely dry miscanthus will be referred to as the water weight fraction in dried biomass (or miscanthus) and in some instances will be expressed as a weight percent. The horizontal axis is a dimensionless ratio of the mass of rainwater incorporated during construction to the rigorously dry miscanthus weight in the dry tomb. This will be referred to as the weight fraction of rainwater incorporated into completely dry biomass (or miscanthus) and in some instances will be expressed as a weight percent. Inspecting FIG. 9 it is seen that a water activity of 0.85 would be achieved if the miscanthus was dried to a point that the water weight fraction in dried biomass was 0.12 (or 12 wt. %), and the fraction of rainwater incorporated into completely dry biomass averaged 0.093 (or 9.3 wt. %). To illustrate the meaning of this we consider the amount of rainwater that would have to be distributed uniformly throughout the dry tomb to obtain 9.3 wt %. For a dry tomb structure with an average thickness of 100 feet containing miscanthus compressed to a bulk density of 0.85 g/cc this would correspond to uniform incorporation of 94 inches of rainfall over the entire surface of the dry tomb being filled. This is an extremely large amount of rainfall and with protection from tarps or other temporary water barriers incorporations of less than 2 inches are expected. A water activity of 0.75 would be achieved if the miscanthus was dried to a point that the water weight fraction in dried biomass was 0.12 (or 12 wt. %), and the fraction of rainwater incorporated into completely dry biomass averaged 0.045 (or 4.5 wt. %). For the same dry tomb structure with an average thickness of 100 feet containing miscanthus compressed to a bulk density of 0.85 g/cc this would correspond to uniform incorporation of 46 inches of rainfall over the entire surface of the dry tomb being filled. A water activity of 0.6 would be achieved if the miscanthus was dried to a point that the water weight fraction in dried biomass was 0.12 (or 12 wt. %), and the fraction of rainwater incorporated into completely dry biomass averaged 0.009 (or 0.9 wt. %). For the same dry tomb structure with an average thickness of 100 feet containing miscanthus compressed to a bulk density of 0.85 g/cc this would correspond to uniform incorporation of 9.2 inches of rainfall over the entire surface of the dry tomb being filled. If the biomass thickness in the dry tomb was 50 feet instead of 100 feet then the maximum amount of rainfall that could be uniformly incorporated into miscanthus that had been dried to a water content of 12 wt. % would be 47 inches for a water activity of 0.85, or 23 inches for a water activity of 0.75, or 4.6 inches for a water activity of 0.6. These examples provide a way of scaling to other dry tomb thicknesses such as 25 feet and 150 feet.

FIG. 9 also shows a water activity 0.85 would be achieved if the miscanthus was dried to a point that the water weight fraction in dried biomass was 0.08 (or 8 wt. %), and the fraction of rainwater incorporated into completely dry biomass averaged 0.13 (or 13 wt. %). For a 100 feet thick dry tomb structure containing miscanthus compressed to a bulk density of 0.85 g/cc this would correspond to uniform incorporation of 132 inches of rainfall over the entire surface of the dry tomb being filled. A water activity 0.75 would be achieved if the miscanthus was dried to a point that the water weight fraction in dried biomass was 0.08 (or 8 wt. %), and the fraction of rainwater incorporated into completely dry biomass averaged 0.085 (or 8.5 wt. %). For the same dry tomb structure with an average thickness of 100 feet containing miscanthus compressed to a bulk density of 0.85 g/cc this would correspond to uniform incorporation of 86 inches of rainfall over the entire surface of the dry tomb being filled. A water activity 0.6 would be achieved if the miscanthus was dried to a point that the water weight fraction in dried biomass was 0.08 (or 8 wt. %), and the fraction of rainwater incorporated into completely dry biomass averaged 0.048 (or 4.8 wt. %). For the same dry tomb structure with an average thickness of 100 feet containing miscanthus compressed to a bulk density of 0.85 g/cc this would correspond to uniform incorporation of 49 inches of rainfall over the entire surface of the dry tomb being filled. These results can also be scaled to other dry tomb thicknesses such as 25 feet and 150 feet.

### Example 8

This example discusses preferred methods to exclude rain during construction of dry tomb biolandfills and achieve a water activity of less than 0.85 in sequestered biomass and will be illustrated for construction of a biolandfill design which is not directly verifiable, mitigatable, or repairable. This is the simplest design of a biolandfill, however the methods described apply to all verifiable, mitigatable, or repairable biolandfills. This simplest biolandfill design contains a dry tomb structure formed by top and bottom seal structures that contain at least one water transport barrier that encloses compressed biomass. In this design there is no piping structure running from the dry tomb through the dirt cover to the earth's surface. During construction it is extremely important to mitigate the influx of rainwater into biomass being placed within the region that will become the dry tomb. Dryness requirements in Example 7 were illustrated with the amount of rainwater that would have to be distributed uniformly throughout the dry tomb. Rainstorms are intermittent events and as such the amount of rainwater falling fluctuates dramatically. Over long periods of time the rainwater incorporated in the biolandfill would uniformly distribute, however biomass degradation would occur while the rainwater redistributed throughout the biomass filled dry tomb structure. To mitigate this it is preferred to limit the amount of rainwater incorporated into the biomass sequestered in the dry tomb structure to less than an amount equivalent to less than 2 wt. % of the mass of completely dry biomass, preferably less than 1 wt. % of the mass of completely dry biomass, even more preferably less than 0.5 wt. % of the mass of completely dry biomass, and most preferably less than 0.2 wt. % of the mass of completely dry biomass. For a 100 feet thick dry tomb structure filled with biomass compressed to an average bulk density of 0.85 g/cc these weight percentages would correspond to uniform incorporation of 20 inches of rainfall over the entire surface of the dry tomb being filled, 10 inches of rainfall over the entire surface of the dry tomb being filled, 5 inches of rainfall over the entire surface of the dry tomb being filled, and 2 inches of rainfall over the entire surface of the dry tomb being filled.

Construction of the simple biolandfill design begins with construction of the base and preparation of the surface on which the bottom seal structure is installed. Provisions are made to drain rainwater from the excavated or graded structures as well as from the biolandfill when it is being filled. Once a portion of the bottom seal has been installed filling with dried biomass can begin. If the dried biomass is compressed and in plastic bags or wrapping it can be placed directly into the dry tomb. Otherwise, the dried biomass is spread across a portion of the dry tomb being constructed and compacted with methods such as dynamic, vibratory, and quasi-static compaction. Dynamic, vibratory, and quasi-static compaction of dried biomass spread across a portion of the dry tomb limits flow of rainwater into the biomass by densifying the biomass and creating hydraulic resistance. The hydraulic resistance is in part due to the closure of gaps and large pore structures in the spread biomass. If a rainstorm with rainfall more than 0.5 inches is predicted biomass filling operations are suspended and rainwater mitigation procedures are completed before the rain event occurs. In a more preferred embodiment if a rainstorm with rainfall more than 0.1 inches is predicted biomass filling operations are suspended and rainwater mitigation procedures are completed before the rain event occurs. Once biomass filling operations are suspended rainwater mitigation procedures are employed. In one embodiment a rainwater mitigation procedure deploys rain protection gear over exposed areas of the dry tomb being constructed. This can involve instillation of temporary plastic sheeting, or tarp systems, geomembranes, geotextiles, or canopies. In another embodiment a regenerable high-capacity sorbent (or sorbents) is used to provide protection from rainwater. If the biomass is being spread and compacted a rainwater mitigation procedure can involve excavation of wet biomass from the dry tomb structure being constructed after the rainstorm has passed. Once excavated the biomass can be dried outside of the construction area. After the rainstorm has passed and rain mitigation procedures are completed the biomass filling operations can resume.

In a preferred embodiment the biolandfill is covered on nights when significant amounts of dew are expected. If dried biomass is being spread and compacted it is possible to forgo the covering and excavate wet biomass from the top surface the next morning. This excavated wet biomass would be dried outside of the construction area.

In view of the many possible embodiments to which the principles of the disclosed invention may be applied, it should be recognized that the illustrative embodiments are only examples of the invention and should not be taken as limiting the scope of the invention.

1. A verifiable dry tomb biolandfill comprising:
a. biomass enclosed by top and bottom seals containing at least one barrier to water transport forming a dry tomb structure,
b. a covering layer containing soil that functions to protect the enclosed biomass from atmospheric disturbance,
c. one or more accessible, sealable solid wall pipes or conduits connected to the enclosed biomass,
d. means to monitor biomass decomposition of the enclosed biomass.

2. The composition of claim 1 wherein the top and bottom seals comprise two or more nested water transport barriers.

3. The composition of claim 2 wherein there is a spacer structure between nested water transport barriers.

4. The composition of claim 3 wherein the spacer structure contains a high-capacity absorbent.

5. The composition of claim 1 wherein the biomass is compressed to a bulk density greater than about 0.2 gram per cubic centimeter.

6. The method of claim 5 wherein dynamic compaction, or vibratory compaction, or quasi-static compaction, or combinations thereof are used to compress the biomass.

7. The composition of claim 1 wherein the water content of the biomass ranges from about 2 wt. % to about 15 wt. %.

8. The composition of claim 7 wherein the amount of rainwater seepage into the biomass sequestered in the dry tomb structure is maintained at less than about 2 wt. % of the mass of completely dry biomass.

9. The composition of claim 1 wherein the water activity of gas within the dry tomb structure is less than 0.85.

10. The composition of claim 1 wherein the Water Vapor Transmission of the barrier to water transport ranges from about 0.00 to 0.5 g/m²/day when measured at about 38° C. with a water activity ranging from about 0.9 to 1.0 on one side and 0.05 or less on the opposite side of the barrier being tested.

11. The composition of claim 1 wherein there is at least one secondary water transport barrier.

12. The composition of claim 11 wherein there is at least one tertiary water barrier.

13. The composition of claim 1 including means for removal of biogas generated in the enclosed biomass wherein the means for biogas removal comprises at least one of the sealable pipes or conduits.

14. The composition of claim 1 with two or more sealable solid wall pipes or conduits connected to said enclosed biomass and a means to flow a gas purge through said pipes or conduits, making the dry tomb biolandfill verifiable and repairable.

15. The composition of claim 14 where means are provided to flow air with a relative humidity of less than about 60% to purge a portion of the dry tomb structure.

16. The composition of claim 14 wherein within the dry tomb at least one perforated pipe or porous pipe or conduit is connected to at least one of the sealable solid wall pipes or conduits.

17. The composition of claim 15 wherein at least a portion of the verifiable and repairable dry tomb biolandfill cycles between aerobic, anoxic, and anaerobic conditions.
